(19) United States
(12) Patent Application Publication
(10) Pub. No.: US 2022/0297697 A1
(43) Pub. Date: Sep. 22, 2022

(54) Systems And Methods For Iced Road Conditions And Remediation

(71) Applicant: Ford Global Technologies, LLC, Dearborn, MI (US)

(72) Inventors: Rohit Bhat, Farmington Hills, MI (US); Scott Thompson, Belleville, MI (US); Douglas Martin, Canton, MI (US); Jesse Brunais, Livonia, MI (US)

(73) Assignee: Ford Global Technologies, LLC, Dearborn, MI (US)

(21) Appl. No.: 17/205,298

(22) Filed: Mar. 18, 2021

(51) Int. Cl. B60W 30/18; B60W 30/02; B60K 35/00; B60W 10/20; B60W 10/00; B60W 30/09; B60W 50/00

(52) U.S. Cl. CPC B60W 30/18172; B60W 30/02; B60K 35/00; B60W 30/18145; B60W 10/20; B60W 10/00; B60W 30/09; B60W 50/00; B60W 2555/20; B60W 2520/125; B60W 2510/20; B60W 2520/26; B60W 2556/65; B60K 2370/16; B60K 2370/152; B60W 2520/10; B60W 2520/06; B60W 2530/00; B60W 2720/24; B60W 2710/00; B60W 2710/20; B60W 2720/10; B60W 2050/0002; B60W 60/0015

(57) ABSTRACT

Systems and methods for iced road conditions and remediation are disclosed herein. A method can include determining an ambient temperature around a vehicle or a road relative to a temperature threshold, determining lateral acceleration of the vehicle due to steering input, determining a slippery condition based on the ambient temperature being below the temperature threshold and the expected lateral acceleration exceeding the measured lateral acceleration by more than a threshold, and selectively adjusting a vehicle operating parameter when the slippery condition is present.

### BACKGROUND

Icing conditions may not be ideal for vehicle operation. Icing conditions can be present even when ice may be visually imperceptible to humans. These situations may be referred to as “black ice” conditions. Black ice refers to situations where roads appear to be dry or merely wet but ice is present.

### BRIEF DESCRIPTION OF THE DRAWINGS

The detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example architecture where the systems and method of the present disclosure may be practiced.

FIG. 2 is an example graphical user interface displaying slippery conditions due to ice on roads that have been marked to enhance driver awareness.

FIG. 3 is a flowchart of an example method of the present disclosure.

FIG. 4 is a flowchart of another example method of the present disclosure.

FIG. 5 is a flowchart of yet another example method of the present disclosure.

### DETAILED DESCRIPTION

### Overview

The present disclosure generally pertains to systems and methods for detecting a slippery condition of a road (or a portion of a road or other surface), including ice and black ice. In some instances, detection of a slippery condition can be based on anti-lock braking system (ABS) wheel slip in a vehicle. When a slippery condition is detected, an example system of the present disclosure can provide a driver or other user with notice of the icy or slippery condition in order for vehicle operator to respond in a precautionary way to avoid loss of control of the vehicle at any speed, including high highway speeds.

The systems and methods may detect a slippery condition by determining wheel slip, turning slip, and/or ambient temperature. The systems and methods can apply a steering stimulus to generate a lateral acceleration output that can be matched against a predetermined profile or baseline for identifying icy conditions. A steering stimulus may be applied by a controller of an autonomous vehicle. For traditional vehicles, steering stimulus can be applied by a driver in the course of normal driving.

The systems and methods can mark and track a GPS location of an iced area and share the GPS location and type of road hazard information to adjacent vehicles (using vehicle-to-vehicle “V2V” communications) and/or a service provider. A vehicle of the present disclosure can also receive slippery condition information from another vehicle or a service provider and providing an indication of a location of a road hazard on a human-machine interface of the vehicle (e.g., visible or audible warning). These warnings can be provided before the vehicle reaching a location that is determined to have an icing or other hazardous condition. In one instance, the vehicle can be configured to detect black ice and transmit a notification to vehicles via a mapping application. These other vehicles can receive this information and engage a slippery mode when they approach the location indicated as having black ice.

Advantageously, these systems and methods allow for advanced detection and mitigation of black ice events. Advanced detection of slippery conditions using the concepts disclosed herein may trigger early driver caution and responses. If icy or slippery conditions are intermittent (i.e., they come and go as the vehicle travels) the vehicle operator can use slippery condition information as cautionary information before a loss of vehicle control. To be sure, while ice and black ice are disclosed in some embodiments the present disclosure is not so limited and other slippery conditions can be detected and remediated using implementations disclosed herein. The systems and methods disclosed herein can be used to increase and improve vehicle control and operation in slippery conditions by providing advanced or immediate warning of slippery road conditions, as well as providing remediating actions for the driver and/or vehicle.

### Illustrative Embodiments

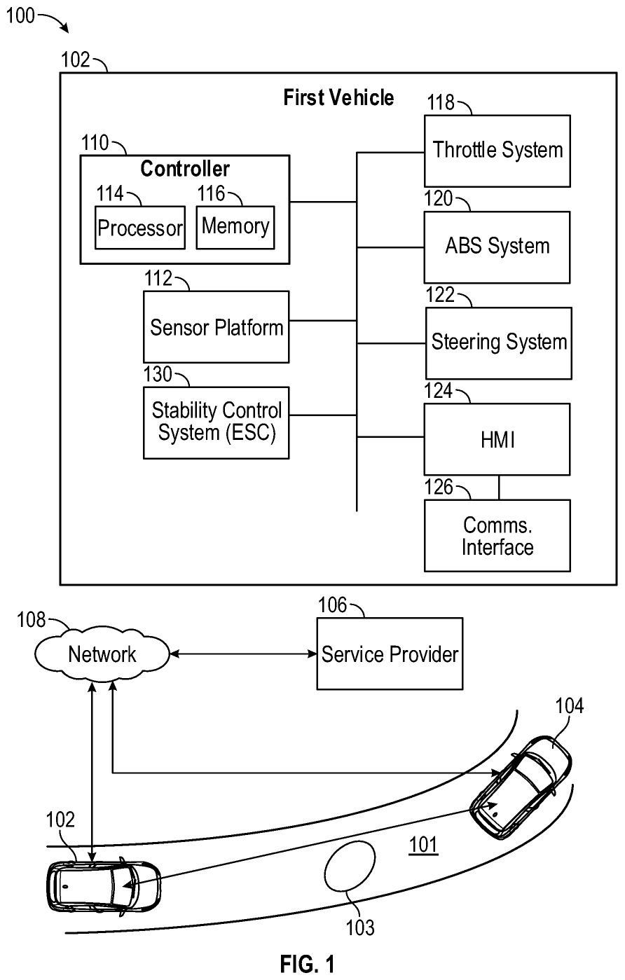

Turning now to the drawings, FIG. 1 depicts an illustrative architecture 100 in which techniques and structures of the present disclosure may be implemented. The architecture 100 can include a first vehicle 102, a second vehicle 104, a service provider 106, and a network 108. Additional or fewer vehicles can be included in some instances. To be sure, the first vehicle 102 and the second vehicle 104 may be a traditional vehicle or an autonomous vehicle. Some or all of these components in the architecture 100 can communicate with one another using the network 108. The network 108 can include combinations of networks that enable the components in the architecture 100 to communicate with one another. The network 108 may include any one or a combination of multiple different types of networks, such as cable networks, the Internet, wireless networks, and other private and/or public networks. In some instances, the network 108 may include cellular, Wi-Fi, or Wi-Fi direct.

The first vehicle 102 and the second vehicle 104 are illustrated as driving on a road 101. A patch of ice or black ice 103 is present on the road 101. In one example, when the second vehicle 104 encounters the patch of ice or black ice 103, the second vehicle 104 can transmit a message to the first vehicle 102 or the service provider 106 that indicates a location of the ice. In other instances, the first vehicle 102 can detect a likelihood that the ice is present based on various factors, as will be disclosed in greater detail herein.

The first vehicle 102 generally comprises a controller 110 and a sensor platform 112. The controller 110 can comprise a processor 114 and memory 116 for storing executable instructions, the processor 114 can execute instructions stored in memory 116 for performing any of the icing condition detection and/or mediation features disclosed herein. Also, the controller 110 can direct signals or messages to one or more vehicle sub-systems, such as a throttle system 118, ABS system 120, and/or steering system 122, based on analysis of the output of the sensor platform 112 and detection (or lack of detection) of a slippery condition of a road. When referring to operations performed by the controller 110, it will be understood that this includes the execution of instructions stored in memory 116 by the processor 114. The first vehicle 102 can also include a human-machine interface (HMI 124), such as an infotainment system, and a communications interface 126 that allows the controller 110 to transmit and/or receive data over the network 108.

In some instances, the controller 110 can receive inputs such as steering wheel position, lateral acceleration, ABS events, brake pressure, wheel torque, and/or wheel slip—just to name a few. These data can be obtained from various vehicle sub-systems or controllers (e.g., controller area network (CAN)). In some instances, a driver of the first vehicle 102 can select to use a slippery mode of vehicle operation through actuation of a button (physical or virtual) provided on or in combination with the HMI 124. In some instances, activation of a slippery mode of operation may be based on detection of road conditions and/or ambient environmental factors.

The sensor platform 112 can include an accelerometer that measures vehicle movement in various directions. The sensor platform 112 can include a location sensing device such as a global positioning sensor (GPS) that tracks the location (such as longitude and latitude) of the first vehicle 102, as well as a temperature sensor that can detect ambient temperature around the first vehicle 102. Other sensors that can detect vehicle location, vehicle movement, and temperature can be used.

The controller 110 can be configured to receive various inputs which the controller 110 can use to determine if an icing condition is present, either in a location where the first vehicle 102 is currently located or in a location where the first vehicle 102 is about to enter. In some instances, the controller 110 can receive information that is indicative of an icing condition and/or location from the service provider 106 or from the second vehicle 104 (based on V2V communications). When the icing condition and/or location is received, the controller 110 can activate an icing or slippery mode. Again, an icing condition is an example slippery condition.

In some instances, advanced warnings or slippery conditions may not be known in advance but can be inferred based on ambient weather conditions. For example, the controller 110 can be configured to determine that an ambient temperature around the first vehicle is less than a temperature threshold (such as 35 degrees Fahrenheit). When the ambient temperature is 35 degrees Fahrenheit or below, the controller 110 can further determine when the speed of the first vehicle is above a threshold speed, such as ten miles per hour. Using these parameters, the controller 110 can automatically trigger a slippery mode of operation for the first vehicle 102.

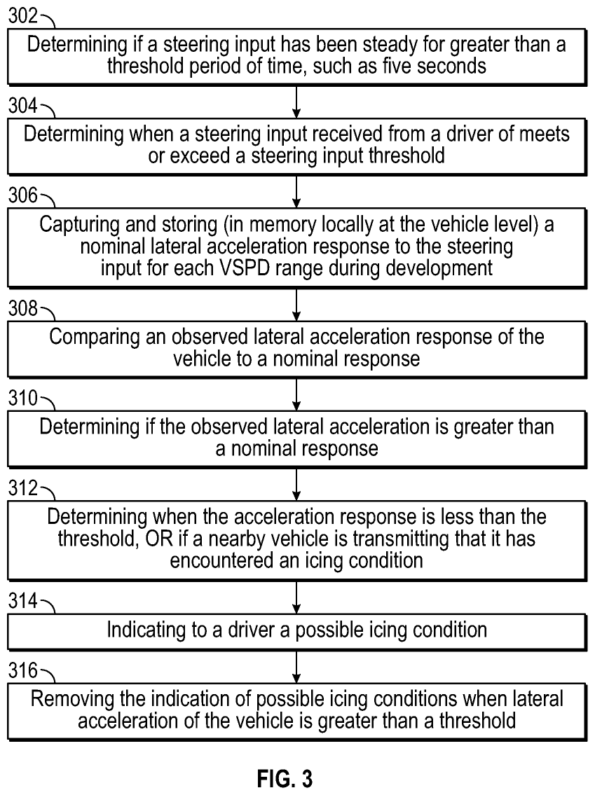

In some instances, the controller 110 can determine a nominal acceleration response when a steering stimulus is present. For example, a driver may turn a steering wheel to produce a steering angle of one degree (other thresholds can be used as well). The steering input can produce an observed lateral response that can be measured based on an output of an accelerometer of the sensor platform 112. The controller 110 can compare this observed lateral response to a nominal or baseline response. For example, a nominal lateral response can be determined for the vehicle that is indicative of how the vehicle would respond to steering input when on a dry road. An icing condition may be present when the observed lateral response is less than a specified value that is less than the nominal lateral acceleration response (i.e. the vehicle is sliding sideways freely instead feeling the lateral acceleration from a turn). An example comparison is provided in greater detail with respect to FIG. 3. Insufficient lateral response may be due to the first vehicle 102 slipping laterally more than would be expected relative to the nominal or baseline response, due to a slippery condition such as ice.

In some instances, the controller 110 can utilize additional information related to heading measurements to determine or infer that a slippery condition may be present on a road. For example, the controller 110 can be configured to determine an expected heading of the vehicle due to steering input, vehicle speed, and a previous heading. The slippery condition determination set forth above may be augmented based on determining when the expected heading disagrees with the measured heading by more than a threshold. The measured heading can be detecting using, for example, GPS or compass heading information obtained from a vehicle sub-system collecting such information, such as a telematics control unit (TCU).

When the lateral acceleration response is less than a nominal lateral response, or when a nearby vehicle is transmitting information indicating that the nearby vehicle (such as the second vehicle 104) has encountered an icing condition, then the icing condition may be flagged for a driver and reported through the HMI 124 of the first vehicle 102.

When a lateral acceleration response is equal or slightly greater than the nominal lateral response (e.g., lateral response threshold), then the controller 110 may clear the icing indication and remove the same from the HMI 124. When an icing condition warning or flag is set by the controller 110 (based on observed data or an indication from another vehicle or service provider), the controller 110 of the first vehicle 102 can reduce gain (e.g., magnitude) of a steering response to avoid lateral slippage. Thus, the controller 110 can transmit signals to the steering system to reduce the gain of a steering response. For example, the controller 110 can damp the steering response. When a driver turns the steering wheel by ten degrees, the input can be damped to three to five degrees, or the steering response may be implemented more gradually where the wheels are turned the full ten degrees of input, but they are turned slowly over a period time rather than immediately.

The controller 110 can also transmit signals to the throttle system 118 to reduce vehicle speed gradually to a threshold speed until the controller 110 determines that the icing condition is no longer present. The controller 110 may also adjust behavior(s) of a stability control system (ESC) 130 and collision avoidance parameters to allow for greatly increased stopping distances and remediate a lack of lateral traction. The controller 110 may also adjust collision avoidance parameters to account for a greater increase in stopping distance. The controller 110 may also provide notifications to other vehicles (such as the second vehicle 104) that an icing condition may be present on a road at a particular location (as determined from GPS signals, for example).

In some instances, the controller 110 can obtain information from the ABS system 120 or traction control system and use that information to engage or disengage a slippery mode for the first vehicle 102. For example, the controller 110 can use a slip detection signal from the ABS system 120 and detection of a low ambient temperature (e.g., any temperature at or below, for example, 35 degrees Fahrenheit) to determine that icing conditions may be present and engage a slippery mode for the first vehicle 102. In some instances, data from the ABS system 120 can be used in combination with lateral acceleration detection to engage the slippery mode for the first vehicle 102.

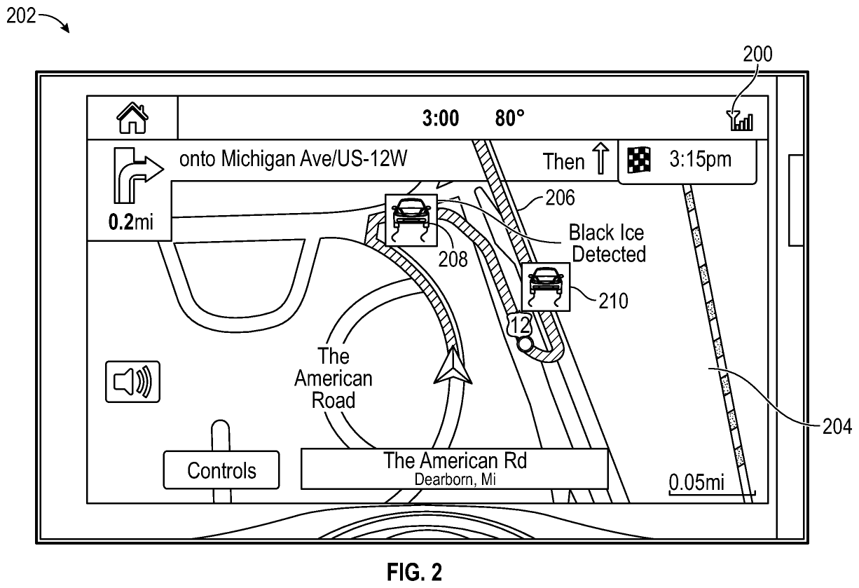

When the controller 110 detects a slippery and/or icing condition of a road using any of the methods disclosed herein, the controller 110 can mark the location(s) where the slippery conditions were detected. These locations can be broadcast to other connected vehicles (such as the second vehicle 104) and/or the service provider 106. The controller 110 can also mark these locations and display the same on a map, as best illustrated in an example graphical user interface of FIG. 2.

Referring now to FIG. 2, a graphical user interface (GUI 200) is illustrated. The GUI 200 can be displayed on an HMI 202 of the vehicle and/or provided on a mobile device of a driver when the vehicle is not equipped with a display screen or infotainment system. The GUI 200 includes a map 204 having a route 206 or navigation path. When an icing or slippery condition is detected, a controller of the vehicle can obtain the location of the vehicle and mark the same on the map 204. In this example, two areas 208 and 210 have been marked on the map 204. The marks can be created when an icing or slippery condition is detected or can be pre-marked based on information obtained from a service provider or another vehicle.

FIG. 3 is a flowchart of an example method related to detecting and mitigating an icing condition. The method can include a step 302 of determining if a steering input has been steady for greater than a threshold period of time, such as five seconds. Next, the method includes a step 304 of determining when a steering input received from a driver of meets or exceed a steering input threshold. In one example, a controller can detect a steering input that exceeds a steering input threshold of one degree (or a range of steering input of one degree, +/−0.2 degrees, inclusive) within a period of time, such as one second. For autonomous vehicles, a controller can occasionally introduce a precise one-degree steering stimulus to obtain a verifiable and controlled response.

The method can include a step 306 of capturing and storing (in memory locally at the vehicle level) a nominal lateral acceleration response to the steering input for each VSPD range during development. The method can also include a step 308 of comparing an observed lateral acceleration response of the vehicle to a nominal response. For example, the method can include a step 310 of determining if the observed lateral acceleration is greater than a nominal response. In one example use case, the controller can determine that at 0.2 seconds after a steering movement of one degree, a change in acceleration of 0.1 g was sensed in an opposite direction of steering movement. This change in acceleration lasted for 0.2 seconds. In step 312, the method can include determining when the acceleration response is less than the threshold, OR if a nearby vehicle is transmitting that it has encountered an icing condition. If either of these conditions is present, the method can include a step 314 of indicating to a driver a possible icing condition. Again, this can include a possible icing condition at the location of the vehicle, or in a location where the vehicle may enter in the future. For example, a controller of the vehicle can review a navigation route for the vehicle created by a vehicle navigation system. The controller can obtain icing condition messages or warnings from other vehicles on the navigation route that are ahead of the vehicle.

In step 316, the method can include a step of removing the indication of possible icing conditions when lateral acceleration of the vehicle is greater than a threshold. The process of testing and comparing lateral acceleration can be done on a periodic basis. As noted above, the testing and comparison can be done when ambient temperatures are below a temperature threshold.

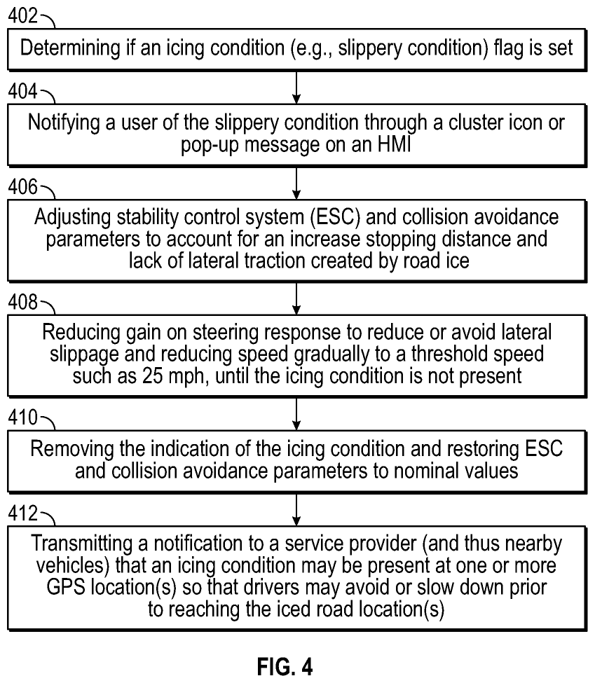

FIG. 4 is a flowchart of another example method. The method can include a step 402 of determining if an icing condition (e.g., slippery condition) flag is set. If so, the method can include a step 404 of notifying a user of the slippery condition through a cluster icon or pop-up message on an HMI.

Generally, a controller of the vehicle can be configured to adjust one or more vehicle operating parameters in response to the icing condition of the road. This adjustment of one or more vehicle operating parameters can increase a likelihood that the vehicle can adapt operation on an icy road. For example, the method can include a step 406 of adjusting stability control system (ESC) and collision avoidance parameters to account for an increase in required stopping distance and lack of lateral traction created by road ice. In some instances, such as when the vehicle is autonomous, the method can include a step 408 of reducing gain on steering response to reduce or avoid lateral slippage and reducing speed gradually to a threshold speed such as 25 mph, until the icing condition is not present.

If an icing condition is not present, the method can include as step 410 of removing the indication of the icing condition and restoring ESC and collision avoidance parameters to nominal values. When the vehicle is a connected vehicle, the method can include a step 412 of transmitting a notification to a service provider (and thus nearby vehicles) that an icing condition may be present at one or more GPS location(s) so that drivers may avoid or slow down prior to reaching the iced road location(s).

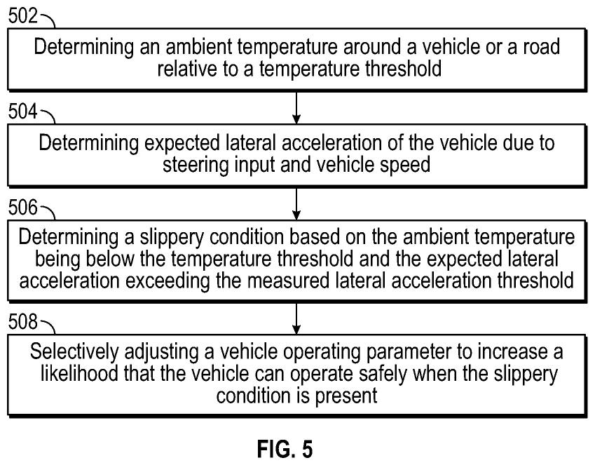

FIG. 5 is a flowchart of an example method of the present disclosure. The method can include a step 502 of determining an ambient temperature around a vehicle or a road relative to a temperature threshold. The temperature data can be obtained from an on-board vehicle sensor or from a weather service. The method can include a step 504 of determining the lateral acceleration of the vehicle due to steering input. For example, a one-degree steering input can be detected. Based on the detected steering input, the method can include a step 506 of determining a slippery condition when the ambient temperature is below the temperature threshold, and the expected lateral acceleration exceeds the measured lateral acceleration by a threshold. In some instances, the lateral acceleration can exceed a lateral acceleration threshold as compared to a baseline response. For example, a baseline response would include lateral acceleration of the vehicle on a prototypical dry road that is similar to the road the vehicle is currently operating over.

The method can include a step 508 of selectively adjusting a vehicle operating parameter to increase a likelihood that the vehicle can adapt operation when the slippery condition is present. For example, this can include damping a braking response or acceleration of the vehicle. In another example, this can include damping or graduating steering input. For example, when a driver steers aggressively, the response can include a moderated steering response. In yet other examples, this can include adjusting stability control system (ESC) and collision avoidance parameters to account for an increase in required stopping distance and lack of lateral traction created by road ice. Another example includes reducing gain on steering response to reduce or avoid lateral slippage and/or reducing speed gradually to a threshold speed.

In some instances, the determination that the vehicle has encountered a slippery condition can be influenced by evaluating expected and measure vehicle heading information. For example, the method can include a step of determining an expected heading of the vehicle due to the steering input, the vehicle speed, and a previous heading. The slippery condition determination may be further based on determining when the expected heading disagrees with the measured heading by more than a threshold.

The method can further include a step of determining wheel slippage from an anti-lock braking system of the vehicle as the vehicle is driving across a road. The slippery condition can further be determined based on a message received from another vehicle or a service provider. It will be understood that the message includes a location of the slippery condition on a road.

The method can include a step of marking a map with a location, where the map is displayed on a human-machine interface of the vehicle. When the location of the vehicle when the slippery condition is determined, the method can include the vehicle broadcasting the location to a service provider or another vehicle and an indication of the slippery condition.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general purpose computer, special purpose computer, or special purpose processing device to perform a certain function or group of functions. An implementation of the devices, systems, and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims may not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method comprising:
determining an ambient temperature around a vehicle or a road relative to a temperature threshold;
determining expected lateral acceleration of the vehicle due to steering input and vehicle speed;
determining a slippery condition based on the ambient temperature being below the temperature threshold and the expected lateral acceleration exceeding a measured lateral acceleration threshold; and
selectively adjusting a vehicle operating parameter when the slippery condition is present.

2. The method according to claim 1, wherein determining the slippery condition comprises determining wheel slippage from an anti-lock braking system or a traction control system of the vehicle as the vehicle is driving across the road.

3. The method according to claim 1, wherein determining the slippery condition comprises receiving a message from another vehicle or a service provider, the message comprising a location of the slippery condition on the road, and further comprising marking a map with the location, the map being displayed on a human-machine interface of the vehicle.

4. The method according to claim 1, further comprising determining an expected heading of the vehicle due to the steering input, the vehicle speed, and a previous heading, wherein determining the slippery condition is further based the expected heading disagreeing with a measured heading by more than a threshold.

5. The method according to claim 1, further comprising:
determining a location of the vehicle when the slippery condition is determined; and
broadcasting the location to a service provider or another vehicle and an indication of the slippery condition.

6. The method according to claim 1, wherein selectively adjusting the vehicle operating parameter comprises adjusting a stability control system (ESC) and collision avoidance parameters to account for an increase stopping distance and lack of lateral traction caused by black ice on the road.

7. The method according to claim 1, wherein selectively adjusting the vehicle operating parameter comprises reducing gain on a steering response of the vehicle to reduce lateral slippage and reducing a speed of the vehicle gradually to a threshold speed.

8. The method according to claim 1, wherein the expected lateral acceleration exceeds the measured lateral acceleration threshold as compared to a baseline response.

9. A system comprising:
a processor; and
a memory for storing instructions, the processor executing the instructions to:
determine an ambient temperature around a vehicle;
determine an expected lateral acceleration of the vehicle due to a steering input;
determine a slippery condition when the ambient temperature is at or below a temperature threshold and the expected lateral acceleration exceeds a lateral acceleration threshold; and
selectively adjust a vehicle operating parameter when the slippery condition is present.

10. The system according to claim 9, wherein the processor is configured to provide the steering input periodically.

11. The system according to claim 9, wherein the processor is configured to selectively adjust the vehicle operating parameter when a message is received from another vehicle or a service provider that indicates that the slippery condition is present.

12. The system according to claim 9, wherein the processor is configured to determine wheel slippage from an anti-lock braking system or a traction control system of the vehicle.

13. The system according to claim 12, wherein the processor is configured to determine an expected heading of the vehicle due to the steering input, a vehicle speed and a previous heading, wherein the processor determines the slippery condition based on the expected heading disagreeing with a measured heading by more than a threshold.

14. The system according to claim 9, wherein the processor is configured to adjust a stability control system (ESC) of the vehicle and collision avoidance parameters to account for an increase stopping distance and lack of lateral traction due to the slippery condition.

15. The system according to claim 9, wherein the processor is configured to:
reduce gain on a steering response of the vehicle to reduce lateral slippage; and
reduce a speed of the vehicle gradually to a threshold speed.

16. A method comprising:
determining an ambient temperature around a vehicle relative to a temperature threshold;
determining lateral acceleration of the vehicle due to a steering input;
determining wheel slippage of the vehicle;
determining a slippery condition based on one or more of the ambient temperature being below the temperature threshold, the lateral acceleration exceeding a lateral acceleration threshold, and/or the wheel slippage;
determining a location of the vehicle;
marking the location of the vehicle on a map; and
transmitting the location and an indication of the slippery condition to a service provider or another vehicle.

17. The method according to claim 16, wherein the another vehicle is traveling on a route that includes the location, the another vehicle approaching the location and being provided advanced notice of the slippery condition.

18. The method according to claim 16, further comprising adjusting a stability control system (ESC) and collision avoidance parameters to account for an increase stopping distance and lack of lateral traction caused by the slippery condition.

19. The method according to claim 16, further comprising reducing gain on a steering response of the vehicle to reduce lateral slippage.

20. The method according to claim 16, further comprising reducing a speed of the vehicle gradually to a threshold speed.
